(19) United States
(12) Patent Application Publication
(10) Pub. No.: US 2026/0086765 A1
(43) Pub. Date: Mar. 26, 2026

(54) DEVICE CONTROL METHOD AND ELECTRONIC DEVICE

(71) Applicant: Acer Incorporated, New Taipei City (TW)

(72) Inventors: Yu-Shan Ruan, New Taipei City (TW); Liang-Chi Chen, New Taipei City (TW)

(73) Assignee: Acer Incorporated, New Taipei City (TW)

(21) Appl. No.: 18/936,907

(22) Filed: Nov. 4, 2024

(30) Foreign Application Priority Data
Sep. 23, 2024 (TW) 113135923

(51) Int. Cl. G06F 3/16; G06V 20/50

(52) U.S. Cl. CPC G06F 3/165; G06V 20/50

(57) ABSTRACT

A device control method and an electronic device are disclosed. The method includes: performing a screen capture operation on a display of the electronic device based on a screen capture frequency to obtain a plurality of screenshot images during a period when the display presents a screen image; analyzing the screenshot images by an image analyzation model to detect a type of the screen image and obtain a detection result; and adjusting the screen capture frequency and at least one setting parameter of the electronic device according to the detection result.

### CROSS-REFERENCE TO RELATED APPLICATION

This application claims the priority benefit of Taiwan application serial no. 113135923, filed on Sep. 23, 2024. The entirety of the above-mentioned patent application is hereby incorporated by reference herein and made a part of this specification.

### BACKGROUND

### Technical Field

The invention relates to a device control method and an electronic device.

### Description of Related Art

Traditionally, when user uses an electronic device (such as personal computer or smartphone) for entertainment activities such as online meeting or watching movie, the electronic device does not actively optimize the electronic device's sound and/or image output. Even though some types of electronic devices (such as smartphones) use pupil detection technology to detect whether the user is watching the screen and actively pause video playback, this technology does not involve simply optimization for the sound and/or image output of the electronic device. Therefore, traditionally when presenting different types of image scenes, user can only manually adjust the sound and/or image output of the electronic device to optimize the current sensory experience. In addition, if image analysis technology is simply applied to real-time image analysis for controlling the sound and/or image output, it may also lead to a significant increase in the power consumption of the electronic device.

### SUMMARY

The present invention provides a device control method and an electronic device, which can improve the above problems.

A device control method for an electronic device is provided according to an embodiment of the present invention. The method includes: during a period when a display of the electronic device presents a screen image, performing a screen capturing operation on the display based on a screen capturing frequency to obtain a plurality of screen snapshots; analyzing the screen snapshots through an image analyzation model to detect a type of the screen image and obtain a detection result; and adjusting the screen capturing frequency and at least one setting parameter of the electronic device according to the detection result.

An electronic device is provided according to an embodiment of the present invention. The electronic device includes a display, a storage device and a processor. The display is configured to present a screen image. The storage device is configured to store an image analyzation model. The processor is coupled to the display and the storage device and configured to: during a period when the display presents the screen image, perform a screen capturing operation on the display based on a screen capturing frequency to obtain a plurality of screen snapshots; analyze the screen snapshots through the image analyzation model to detect a type of the screen image and obtain a detection result; and adjust the screen capturing frequency and at least one setting parameter of the electronic device according to the detection result.

On the basis above, during a period when a display of the electronic device presents a screen image, a screen capturing operation is performed on the display based on a screen capturing frequency to obtain a plurality of screen snapshots. After the screen snapshots are analyzed through an image analyzation model, a type of the screen image is detected and a corresponding detection result is obtained. According to the detection result, the screen capturing frequency and at least one setting parameter of the electronic device can be adjusted. Therefore, a better balance, between suppressing of the power consumption generated by the electronic device performing image analysis as much as possible and automatically adjusting of at least one setting parameter of the electronic device based on the image analysis, can be achieved.

### BRIEF DESCRIPTION OF THE DRAWINGS

FIG. 1 is a schematic diagram of an electronic device according to an embodiment of the present invention.

FIG. 2 is a schematic diagram of adjusting the screen capturing frequency and at least one setting parameter of the electronic device according to the type of screen image according to an embodiment of the present invention.

FIG. 3 is a schematic diagram of screen capturing frequencies, first setting parameters and second setting parameters corresponding to different types of scenes according to an embodiment of the present invention.

FIG. 4 is a flow chart of a device control method according to an embodiment of the present invention.

FIG. 5 is a flow chart of a device control method according to an embodiment of the present invention.

### DESCRIPTION OF THE EMBODIMENTS

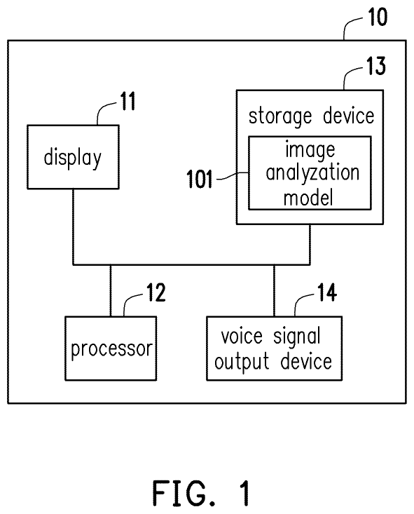

FIG. 1 is a schematic diagram of an electronic device according to an embodiment of the present invention. Referring to FIG. 1, the electronic device 10 may include an electronic device that support image presentation and image processing functions, such as a smartphone, a tablet, a notebook computer, a desktop computer, a server, a game console, or a vehicle-mounted computer, and the type of the electronic device 10 is not limited thereto.

In one embodiment, the electronic device 10 includes a display (also referred to as a display device) 11, a processor 12 and a storage device 13. The display 11 is configured to display an image (also referred to as screen image). For example, the display 11 may include a plasma display, a liquid-crystal display (LCD), a thin film transistor liquid crystal display (TFT-LCD), an organic light-emitting diode (OLED) and a light-emitting diode display (LED display), etc., and the type of display 11 is not limited thereto.

The processor 12 is coupled to the display 11 and the storage device 13. The processor 13 is responsible for controlling of the entire or partial operation of the electronic device 10. For example, the processor 12 may include a central processing unit (CPU), a graphics processing unit (GPU), or other programmable general-purpose or special-purpose microprocessors, digital signal processors (DSP), programmable controller, application specific integrated circuits (ASIC), programmable logic device (PLD) or other similar devices or a combination of these devices.

In one embodiment, the processor 12 may also include a vision processing unit (VPU), a neural network processing unit (NPU), a tensor processing unit (TPU) and/or other processor specifically designed to assist in the execution of a neural network operation and/or an image processing. In addition, the present invention does not limit the number and type of processor 12.

The storage device 13 is configured to store data. For example, the storage device 13 may include a volatile storage circuit and a non-volatile storage circuit. The volatile storage circuit is configured to store data volatilely. For example, the volatile storage circuit may include a random access memory (RAM) or similar volatile storage media. The non-volatile storage circuit is configured to store data in a non-volatile manner. For example, the non-volatile storage circuit may include a read-only memory (ROM), a solid state disk (SSD), a traditional hard disk drive (HDD) or similar non-volatile storage media. In addition, the present invention does not limit the number and type of the storage devices 13.

In one embodiment, the electronic device 10 may further include a voice signal output device 14. The voice signal output device 14 is coupled to the processor 12. The voice signal output device 14 is configured to output sound (such as a voice signal). For example, the voice signal output device 14 may include a speaker and/or a headphone. In addition, the present invention does not limit the number and type of the voice signal output devices 14.

In one embodiment, the electronic device 10 may also include various input/output devices or peripheral devices such as a power management circuit, a network interface card, a mouse, and/or a keyboard, and the types of the input/output devices and the peripheral devices are not limited thereto.

In one embodiment, the storage device 13 is configured to store the image analyzation model 101. The image analyzation model 101 is configured to analyze image data and automatically generate corresponding output information. For example, the image analyzation model 101 may include an artificial intelligence (AI) model, a machine learning (ML) model, and/or a deep learning (DL) model. For example, the image analyzation model 101 can be implemented based on a neural network such as a Deep Neural Network (DNN), a Convolutional Neural Network (CNN), a Recurrent Neural Network (RNN) or other type of algorithm architecture. In one embodiment, the image analyzation model 101 can also be stored in an external device (such as a cloud server). In addition, the image analyzation model 101 can be trained to improve the accuracy of detection and/or analysis.

In one embodiment, the processor 12 may control the display 11 to display an image (i.e., the screen image). For example, according to an application (or a program) currently executed by the processor 12, the display 11 may present the screen image corresponding to the application (or the program). In one embodiment, the display 11 may display a screen image corresponding to an application (or a program) currently executed in foreground.

In one embodiment, during a period when the display 11 presents the screen image, the processor 12 may perform a screen capturing operation on the display 11 based on a frequency (also referred to as a screen capturing frequency) to obtain a plurality of snapshots (also referred to as screen snapshots). For example, the screen capturing operation may be configured to perform an image capturing (also referred to as snapshotting) on the screen image currently presented by the display 11 to obtain the screen snapshots. For example, in the screen capturing operation, once the image capturing is performed on the screen image presented by the display 11, one of the screen snapshots can be obtained.

In one embodiment, the screen capturing frequency may reflect or control the number of times of the image capturing performed on the screen image presented by the display 11 within each unit time range (e.g., 1 second or other time unit). For example, the screen capturing frequency may be positively correlated to the number of times of the image capturing being performed on the screen image presented by the display 11 within each unit time range. That is, if the screen capturing frequency is higher, the screen image presented by the display 11 is image captured more times in each unit time range.

In one embodiment, the screen capturing frequency may be configured to control a total number of the screen snapshots obtained through the screen capturing operation. For example, the screen capturing frequency may be positively correlated to the total number of the screen snapshots obtained through the screen capturing operation. That is, if the screen capturing frequency is higher (i.e., the screen image presented by the display 11 being image captured more times in each unit time range), the total number of screen snapshots obtained through the screen capturing operation is larger.

In one embodiment, after obtaining the screen snapshots, the processor 12 may analyze the screen snapshots through the image analyzation model 101 to detect a type of the screen image presented by the display 11 and obtain a detection result. For example, the detection result may reflect the type of the screen image presented by the display 11 being determined by the image analyzation model 101.

In one embodiment, the processor 12 may sequentially input the screen snapshots to the image analyzation model 101 to analyze the screen snapshots one by one (or in parallel) through the image analyzation model 101. In the process of analyzing the screen snapshots, the image analyzation model 101 may detect or analyze the pixel composition of at least part of the images in the screen snapshots to detect the type of the screen image presented by the display 11 and then generate an output value. The output value may reflect the detection result of the image analyzation model 101 for the type of the screen image presented by the display 11.

In one embodiment, within a unit time range, the total number of images (such as the screen snapshots) analyzed by the image analyzation model 101 may be positively correlated to the power consumption of the image analyzation model 101, and the power consumption of the image analyzation model 101 may be positively correlated to the power consumption of the electronic device 10. That is, if the total number of images (such as the screen snapshots) analyzed by the image analyzation model 101 is greater within the unit time range, the power consumption of the image analyzation model 101 may be higher, and the power consumption of the electronic device 10 may also be greater.

In one embodiment, by increasing the screen capturing frequency to increase the total number of screen snapshots analyzed by the image analyzation model 101, the detection efficiency (such as detection accuracy) of the image analyzation model 101 for the type of the screen image may be improved, but it may also simultaneously increase the power consumption of the image analyzation model 101 (and the power consumption of the electronic device 10). However, if the total number of screen snapshots analyzed by the image analyzation model 101 is reduced by reducing the screen capturing frequency, the power consumption of the image analyzation model 101 (and the power consumption of the electronic device 10) may be reduced, but it may correspondingly reduce the detection efficiency (such as the detection accuracy) of the image analyzation model 101 for the type of the screen image. Therefore, how to automatically adjust the screen capturing frequency under different situations or different time points to achieve a better balance between the detection efficiency (such as detection accuracy) of the image analyzation model 101 for the type of screen image and the power consumption of the image analyzation model 101 (and the power consumption of the electronic device 10) is actually one of the difficult problems in this technical field.

In one embodiment, after analyzing the screen snapshots through the image analyzation model 101 to obtain the detection result, the processor 12 may adjust the screen capturing frequency according to the detection result. Thereby, a better balance may be effectively achieved between the detection efficiency (such as detection accuracy) of the image analyzation model 101 for the type of screen image and the power consumption of the image analyzation model 101 (and the power consumption of the electronic device 10).

In one embodiment, the processor 12 may automatically adjust the screen capturing frequency according to a scene type of the screen image presented by the display 11 reflected by the detection result. For example, if the detection result reflects that the screen image presented by the display 11 belongs to a certain type of image scene (also referred to as a first type scene), the processor 12 may set the screen capturing frequency to a certain frequency (also referred to as a first screen capturing frequency). Alternatively, if the detection result reflects that the screen image presented by the display 11 belongs to another type of image scene (also referred to as a second type scene), the processor 12 may set the screen capturing frequency to another frequency (also referred to as a second screen capturing frequency). The first type scene is different from the second type scene, and the first screen capturing frequency may be different from the second screen capturing frequency.

In one embodiment, the adjusted screen capturing frequency may be positively correlated to a color variation rate of the screen image presented by the display 11. For example, the color variation rate may reflect a color variation amount or a variation degree of the screen image within the unit time range. For example, the color variation rate may be positively correlated to the color variation amount or the variation degree of the screen image within the unit time range. That is, if the color variation rate is higher, the color variation amount or the variation degree of the screen image within the unit time range is larger.

In one embodiment, if the detection result reflects that the scene type of the screen image presented by the display 11 is a scene type with a relatively high color variation rate (such as an action game or a movie with strong sound and light effects, etc.), then the processor 12 may increase the screen capturing frequency (or set the screen capturing frequency to be a relatively high frequency value). Alternatively, if the detection result reflects that the scene type of the screen image presented by the display 11 is a scene type with a relatively low color variation rate (such as word processing, music playing or web browsing, etc.), the processor 12 may reduce the screen capturing frequency (or set the screen capturing frequency to a relatively low frequency value). Thereby, a better balance may be effectively achieved between the detection efficiency (such as detection accuracy) of the image analyzation model 101 for the type of screen image and the power consumption of the image analyzation model 101 (and the power consumption of the electronic device 10).

In one embodiment, after analyzing the screen snapshots through the image analyzation model 101 to obtain the detection result, the processor 12 may further adjust at least one setting parameter of the electronic device 10 according to the detection result. For example, according to the detection result, the processor 12 may adjust at least one setting parameter (also referred to as first setting parameter) of the display 11 and/or at least one setting parameter (also referred to as second setting parameter) of the voice signal output device 14.

In one embodiment, the at least one first setting parameter may be configured to change display setting (such as frequency setting, brightness, contrast and/or resolution, etc.) of the display 11, and the type of the display setting of the display 11 which may be changed by the first setting parameter is not limited thereto. In one embodiment, the at least one second setting parameter may be configured to change the voice signal output setting of the voice signal output device 14 (such as the volume setting of the left and right channels, etc.), and the type of the voice signal output setting of the voice signal output device 14 which may be changed by the second setting parameter is not limited thereto.

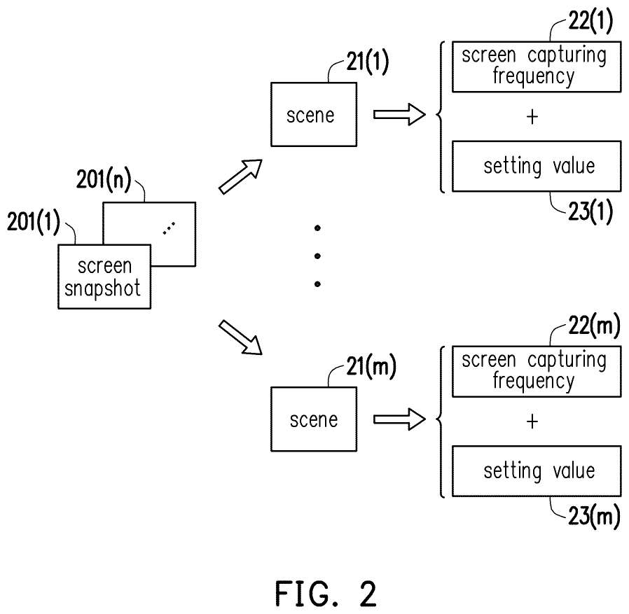

FIG. 2 is a schematic diagram of adjusting the screen capturing frequency and at least one setting parameter of the electronic device according to the type of screen image according to an embodiment of the present invention. Referring to FIG. 1 and FIG. 2, it is assumed that during the period when the display 11 presents a screen image, the processor 12 performs a screen capturing operation on the display 11 based on a screen capturing frequency to obtain screen snapshots 201(1)-201(n). For example, the total number of the screen snapshots 201(1)-201(n) may be controlled by the screen capturing frequency. For example, the total number of the screen snapshots 201(1)-201(n) may be positively correlated to the screen capturing frequency.

In one embodiment, the processor 12 may analyze the screen snapshots 201(1)-201(n) through the image analyzation model 101 to obtain a detection result. According to the detection result, the processor 12 may determine that the screen image currently displayed by the display 11 belongs to one of the scenes 21(1)-21(m). The scenes 21(1)-21(m) correspond to screen capturing frequencies 22(1)-22(m) and setting values 23(1)-23(m) respectively.

In one embodiment, if the screen image currently displayed by the display 11 belongs to the scene 21(1), the processor 12 may obtain the screen capturing frequency 22(1) and the setting value 23(1). Then, the processor 12 may set (e.g., adjust or update) the screen capturing frequency based on the screen capturing frequency 22(1). In addition, the processor 12 may set (e.g., adjust or update) at least one setting parameter (e.g., first setting parameter and/or second setting parameter) of the electronic device 10 according to the setting value 23(1).

Alternatively, in one embodiment, if the screen image currently displayed by the display 11 belongs to the scene 21(m), then the processor 12 may obtain the screen capturing frequency 22(m) and the setting value 23(m). Then, the processor 12 may set (e.g., adjust or update) the screen capturing frequency based on the screen capturing frequency 22(m). In addition, the processor 12 may set (e.g., adjust or update) at least one setting parameter (e.g., first setting parameter and/or second setting parameter) of the electronic device 10 according to the setting value 23(m), and so on.

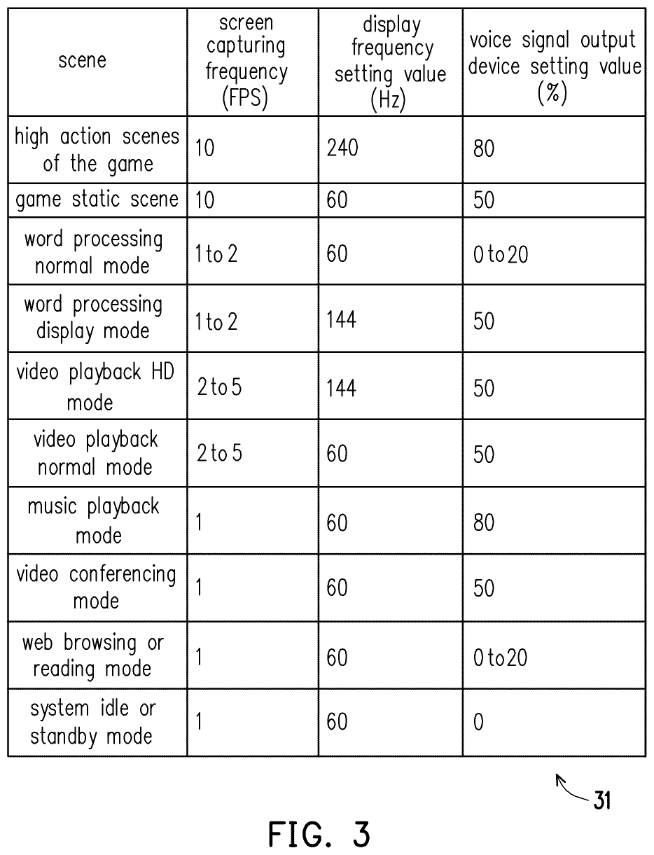

FIG. 3 is a schematic diagram of screen capturing frequencies, first setting parameters and second setting parameters corresponding to different types of scenes according to an embodiment of the present invention. Referring to FIG. 1 and FIG. 3, in one embodiment, the processor 12 may record the screen capturing frequencies, first setting parameters and second setting parameters corresponding to different types of scenes in the setting table 31. The unit of the screen capturing frequency may be frame per second (FPS). The first setting parameter may include a display frequency setting value, and the unit of the display frequency setting value may be hertz (Hz). The second setting parameter may include a voice signal output device setting value, and the unit of the voice signal output device setting value may be percentage (%). For example, the voice signal output device setting value may be configured to control the output volume of at least one channel of the voice signal output device 14.

In one embodiment of FIG. 3, for different types of scenes listed in the setting table 31 (such as game high action scenes, game static scenes, word processing normal mode, etc.), different screen capturing frequencies, first setting parameters and second setting parameters may be applied (or read).

Taking FIG. 2 as an example, assuming that the currently detected screen image belongs to scene 21(i), and the scene 21(i) is a high action scene of the game, then the processor 12 may query the data table 31 to obtain the screen capturing frequency 22(i) being “10 (FPS)” and the setting value 23(i) being “240 (Hz)” and “80%”. Based on the screen capturing frequency 22(i), the processor 12 may set (e.g., adjust or update) the screen capturing frequency to “10 (FPS).” In addition, according to the setting value 23(i), the processor 12 may set (e.g., adjust or update) the first setting parameter (e.g., the frequency setting of the display 11) to be “240 (Hz)”, and set the second setting parameter (e.g., the volume of the voice signal output device 14) to be “80%” of the maximum volume.

Alternatively, assuming that the currently detected screen image belongs to scene 21(j), and the scene 21(j) is a word processing normal mode, then the processor 12 may query the data table 31 to obtain the screen capturing frequency 22(j) being “1 to 2 (FPS)” and the setting value 23(j) being “60 (Hz)” and “0 (silent) to 20%”. Based on the screen capturing frequency 22(j), the processor 12 may set (e.g., adjust or update) the screen capturing frequency to “1 to 2 (FPS).” In addition, according to the setting value 23(j), the processor 12 may set (e.g., adjust or update) the first setting parameter (e.g., the frequency setting of the display 11) to be “60 (Hz)”, and set the second setting parameter (e.g., the volume of the voice signal output device 14) to be “0 (silent) to 20%” of the maximum volume.

In one embodiment, the processor 14 may further obtain adjustment ability information of the electronic device 10 for the at least one setting parameter (e.g., first setting parameter and/or second setting parameter). For example, the adjustment ability information may be provided by the controller or the control firmware of the display 11 and/or the voice signal output device 14. Then, the processor 14 may adjust the screen capturing frequency according to the adjustment ability information.

In one embodiment, the adjustment ability information may reflect at least one of an adjustment times upper limit and an adjustment range upper limit of the electronic device 10 for the at least one setting parameter (such as the first setting parameter and/or the second setting parameter) within each unit time range. For example, the adjustment ability information may reflect an adjustment times upper limit of the electronic device 10 for the first setting parameter of the display 11 and/or the second setting parameter of the voice signal output device 14 within each unit time range being “2 times” and/or the adjustment range upper limit within each unit time range being “10%”of total adjustment range, and the present invention is not limited thereto.

In one embodiment, at least one of the adjustment times upper limit and the adjustment range upper limit may be positively correlated to the adjusted screen capturing frequency. That is, if at least one of the adjustment times upper limit and the adjustment range upper limit is larger, the adjusted screen capturing frequency may be higher.

In one embodiment, the processor 14 may adjust the screen capturing frequency according to the type of screen image presented by the display 11 and the adjustment ability information, synchronously. For example, in one embodiment, it is assumed that the screen capturing frequency obtained according to the detected type of screen image presented by the display 11 is “10 (FPS)”. However, the adjustment ability information reflects the adjustment times upper limit of the electronic device 10 for the second setting parameter of the voice signal output device 14 within each unit time range being relatively low. In this case, the processor 14 may further reduce the screen capturing frequency from “10 (FPS)” to “8 (FPS)”. In this way, the power consumption of the image analyzation model 101 (and the power consumption of the electronic device 10) may be further reduced without affecting the output audio adjustment of the voice signal output device 14.

Alternatively, in one embodiment, it is assumed that the screen capturing frequency obtained according to the detected type of screen image presented by the display 11 is “10 (FPS)”. However, the adjustment ability information reflects the adjustment times upper limit of the electronic device 10 for the second setting parameter of the voice signal output device 14 within each unit time range being relatively high. In this case, the processor 14 may further increase the screen capturing frequency from “10 (FPS)” to “12 (FPS)”. In this way, although the power consumption of the image analyzation model 101 (and the power consumption of the electronic device 10) may be slightly increased, more precise control of the output audio of the voice signal output device 14 may be achieved, thereby further improving the user experience.

In other words, the above embodiments reduce the inference times of AI plug-in program (such as the image analyzation model 101) by dynamic interaction between the AI plug-in program and hardware devices (such as the display 11 and/or the voice signal output device 14), which may optimize resource utilization and improve hardware performance. In addition, in one embodiment, the screen snapshots may be replaced by an image source of at least one camera as the input of the AI plug-in program (such as the image analyzation model 101), which is not limited thereto.

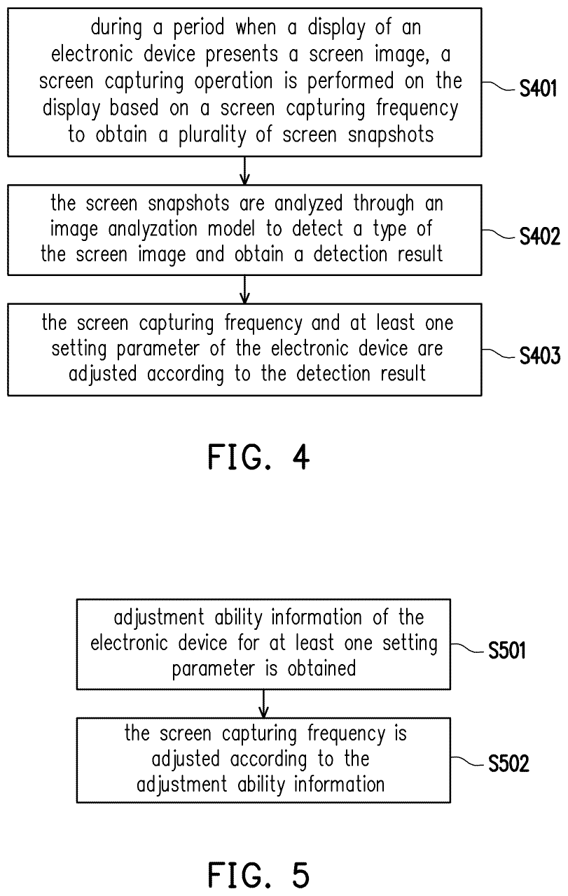

FIG. 4 is a flow chart of a device control method according to an embodiment of the present invention. Referring to FIG. 4, in step S401, during a period when a display of an electronic device presents a screen image, a screen capturing operation may be performed on the display based on a screen capturing frequency to obtain a plurality of screen snapshots. In step S402, the screen snapshots may be analyzed through an image analyzation model to detect a type of the screen image and obtain a detection result. In step S403, the screen capturing frequency and at least one setting parameter of the electronic device may be adjusted according to the detection result.

FIG. 5 is a flow chart of a device control method according to an embodiment of the present invention. Referring to FIG. 5, in step S501, adjustment ability information of the electronic device for at least one setting parameter may be obtained. In step S502, the screen capturing frequency may be adjusted according to the adjustment ability information.

However, each step in FIG. 4 and FIG. 5 has been described in detail above, and will not be described again here. It is worth noting that each step in FIG. 4 and FIG. 5 may be implemented as multiple program codes or circuits, and the present invention is not limited thereto. In addition, the methods of FIG. 4 and FIG. 5 may be used in conjunction with the above exemplary embodiments or may be used alone, and are not limited by the present invention.

Based on the above, the present invention may provide the following benefits:
1. Dynamic interaction between AI plug-in program and hardware devices: this invention emphasizes the interaction and data exchange between AI plug-in programs and hardware devices (such as audio equipment or displays). The hardware device provides feedback information, and the AI plug-in program adjusts functions accordingly. This two-way communication allows the AI to optimize parameter settings based on the hardware status.
2. Reduce the reference times of AI model and save computing resources: through the parameter feedback provided by the hardware device, the AI plug-in program may adjust the model input/output, thereby reducing the number of unnecessary inferences and greatly saving system resources, especially when high performance and low latency is required.
3. Adaptive parameter adjustment: this invention emphasizes that the AI plug-in program automatically adjusts functions according to the parameters fed back by the hardware device, without relying on the complete AI inference process every time. This adaptive parameter optimization mechanism may improve system efficiency and response speed.
4. Applicable to various hardware devices: the present invention may be applied to different types of hardware devices (such as audio devices and displays) and improves performance in different application scenarios, which means that the present invention has broad application potential.

To sum up, the device control method and the electronic device proposed by the embodiments of the present invention may perform feedback adjustment on the screen capturing frequency and at least one setting parameter of the electronic device according to the type of screen image presented by the display. Thereby, a better balance, between suppressing as much as possible of the power consumption generated by the electronic device performing image analysis and automatically adjusting of at least one setting parameter of the electronic device based on said image analysis, may be achieved.

Although the present invention has been disclosed above through embodiments, they are not intended to limit the present invention. Anyone with ordinary knowledge in the relevant technical field can make some changes and modifications without departing from the spirit and scope of the present invention. Therefore, the protection scope of the present invention shall be determined by the appended patent application scope.

What is claimed is:

1. A device control method for an electronic device, comprising:
during a period when a display of the electronic device presents a screen image, performing a screen capturing operation for the display based on a screen capturing frequency to obtain a plurality of screen snapshots;
analyzing the screen snapshots through an image analyzation model to detect a type of the screen image and obtain a detection result; and
adjusting the screen capturing frequency and at least one setting parameter of the electronic device according to the detection result.

2. The device control method of claim 1, wherein the step of adjusting the screen capturing frequency according to the detection result comprises:
if the detection result reflects that the screen image belongs to a first type scene, setting the screen capturing frequency to a first screen capturing frequency; and
if the detection result reflects that the screen image belongs to a second type scene, setting the screen capturing frequency to a second screen capturing frequency, wherein the first type scene is different from the second type scene, and the first screen capturing frequency is different from the second screen capturing frequency.

3. The device control method of claim 1, wherein the adjusted screen capturing frequency is positively correlated to a color variation rate of the screen image presented by the display.

4. The device control method of claim 1, wherein the screen capturing frequency is configured to control a total number of the screen snapshots obtained through the screen capturing operation.

5. The device control method of claim 1, wherein the electronic device comprises the display and a voice signal output device, and the step of adjusting the at least one setting parameter of the electronic device according to the detection result comprises:
adjusting at least one of at least one first setting parameter of the display and at least one second setting parameter of the voice signal output device according to the detection result.

6. The device control method of claim 1, further comprising:
obtaining adjustment ability information of the electronic device for the at least one setting parameter; and
adjusting the screen capturing frequency according to the adjustment ability information.

7. The device control method of claim 6, wherein the adjustment ability information reflects at least one of an adjustment times upper limit and an adjustment range upper limit of the electronic device for the at least one setting parameter within each unit time range.

8. An electronic device, comprising:
a display, configured to present a screen image;
a storage device, configured to store an image analyzation model; and
a processor, coupled to the display and the storage device and configured to:
during a period when the display presents the screen image, perform a screen capturing operation for the display based on a screen capturing frequency to obtain a plurality of screen snapshots;
analyze the screen snapshots through the image analyzation model to detect a type of the screen image and obtain a detection result; and
adjust the screen capturing frequency and at least one setting parameter of the electronic device according to the detection result.

9. The electronic device of claim 8, wherein the operation of adjusting the screen capturing frequency according to the detection result comprises:
if the detection result reflects that the screen image belongs to a first type scene, setting the screen capturing frequency to a first screen capturing frequency; and
if the detection result reflects that the screen image belongs to a second type scene, setting the screen capturing frequency to a second screen capturing frequency, wherein the first type scene is different from the second type scene, and the first screen capturing frequency is different from the second screen capturing frequency.

10. The electronic device of claim 8, wherein the adjusted screen capturing frequency is positively correlated to a color variation rate of the screen image presented by the display.

11. The electronic device of claim 8, wherein the screen capturing frequency is configured to control a total number of the screen snapshots obtained through the screen capturing operation.

12. The electronic device of claim 8, wherein the electronic device further comprises a voice signal output device, and the operation of adjusting the at least one setting parameter of the electronic device according to the detection result comprises:
adjusting at least one of at least one first setting parameter of the display and at least one second setting parameter of the voice signal output device according to the detection result.

13. The electronic device of claim 8, wherein the processor is further configured to:
obtain adjustment ability information of the electronic device for the at least one setting parameter; and
adjust the screen capturing frequency according to the adjustment ability information.

14. The electronic device of claim 13, wherein the adjustment ability information reflects at least one of an adjustment times upper limit and an adjustment range upper limit of the electronic device for the at least one setting parameter within each unit time range.
